(19) United States
(12) Patent Application Publication
(10) Pub. No.: US 2013/0061454 A1
(43) Pub. Date: Mar. 14, 2013

(54) METHOD FOR MANUFACTURING LENS MOLD CORE

(71) Applicant: WEN-SSU CHIU, Tu-Cheng (TW)

(72) Inventor: WEN-SSU CHIU, Tu-Cheng (TW)

(73) Assignee: HON HAI PRECISION INDUSTRY CO., LTD., Tu-Cheng (TW)

(21) Appl. No.: 13/280,304

(22) Filed: Oct. 24, 2011

(30) Foreign Application Priority Data
Sep. 8, 2011 (TW) 100132368

(51) Int. Cl. B23P 13/00

(52) U.S. Cl. 29/558

(57) ABSTRACT

A method for manufacturing a lens mold core includes the following steps. First, a blade is provided. Then, the blade is driven to a number of cutting points in this order from the peripheral to the center of a molding surface of the lens mold core facing the blade at a fixed pitch less than about 500 nm, according to the manufacturing parameters of the lens mold core.

Next, the lens mold core is driven to move toward the blade along a central axis of the molding surface and to spin about the central axis at each cutting point until the blade cuts into the molding surface a desired depth, according to the manufacturing parameters of the lens mold core.

### BACKGROUND

1. Technical Field

The present disclosure relates to molds and, particularly, to a method for manufacturing a high quality lens mold core.

2. Description of Related Art

Typically, lens mold cores are manufactured by cutting. In an example method for manufacturing a lens mold core, a blade is driven to move to a number of cutting points in this order from the peripheral to the center of a molding surface of the lens mold core at a fixed pitch. At each cutting point, the blade points to the molding surface, and the lens mold core is driven to move toward the blade along a direction that is substantially parallel to a central axis of the molding surface and to spin about the central axis until the blade cuts into the molding surface a desired depth corresponding to the cutting point, leaving a circular micro-sized residue between each two adjacent cutting points. The residues cooperatively form a diffractive grating have a spatial cycle equal to the pitch, which will be transferred to a lens molded by the lens mold core and produces a rainbow flare in images captured by the lens.

Therefore, it is desirable to provide a method for manufacturing a lens mold core, which can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a flowchart of a method for manufacturing a lens mold core, according to an embodiment.

FIG. 2 is a schematic view showing how to implement the method of FIG. 1.

### DETAILED DESCRIPTION

Embodiments of the present disclosure will now be described in detail with reference to the drawings.

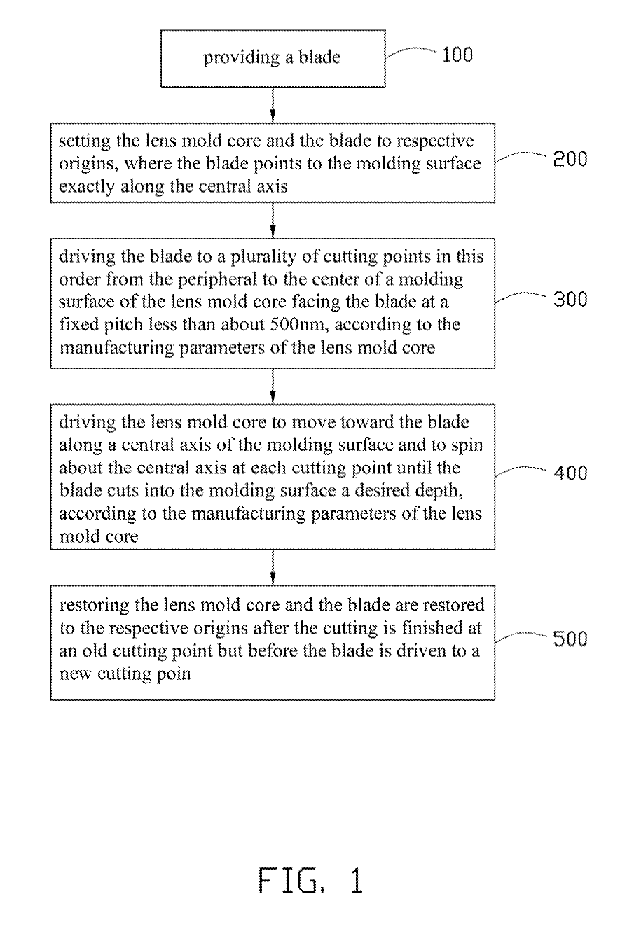

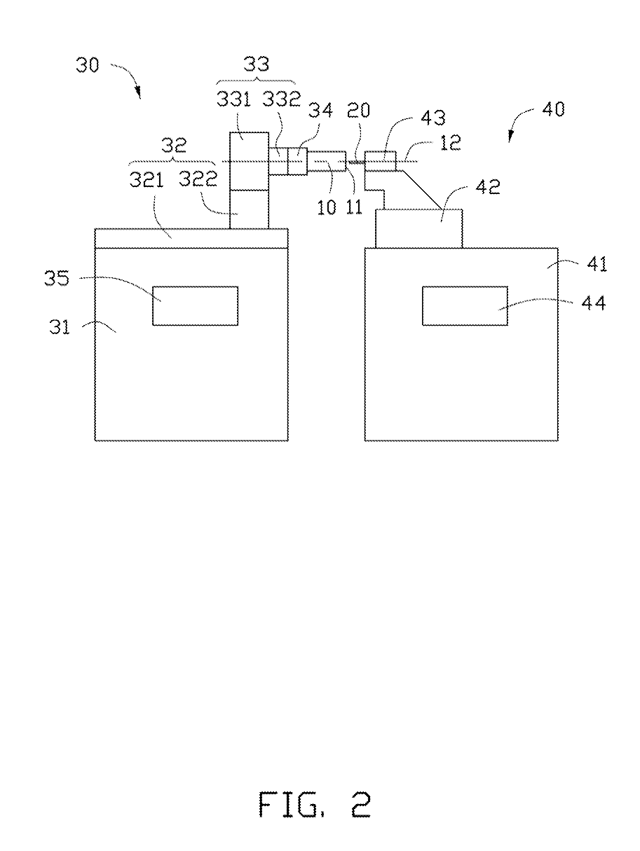

Referring to FIGS. 1-2, an embodiment of a method for manufacturing a lens mold core 10 includes the following steps 100-500.

In step 100, a blade 20 is provided.

The lens mold core 10 includes a molding surface 11 which has a central axis 12. The lens mold core 10 is held and driven by a first driver 30. The first driver 30 includes a first platform 31, a linear motor 32, a rotary motor 33, a first holder 34, and a first controller 35. The linear motor 32 includes a stator 321 positioned on the first platform 31 and a slider 322 movably riding on the stator 321. The linear motor 32 is configured for driving the slider 322 to slidably move on the stator 321. The rotary motor 33 includes a main body 331 connected to the slider 322 and a rotor 332 rotatably extending from the main body 331 along a direction that is substantially parallel to the sliding direction of the slider 322 on the stator 321. The rotary motor 33 is configured for driving the rotor 332 to spin about an axis (no shown), which is parallel to the extending direction thereof, in relative to the main body 331. The first holder 34 is connected to the rotor 332 and configured for holding the lens mold core 10 in a manner that the central axis 12 passes through the axis about which the rotor 332 spins. The first controller 35 is configured for driving the linear motor 32 and the rotary motor 33, according to manufacturing parameters of the lens mold core 10.

The blade 20 is held by a second driver 40. The second driver 40 includes a second platform 41 positioned adjacent to the first platform 31, a height adjuster 42, a second holder 43, and a second controller 44. The height adjuster 42 is positioned on the second platform 41. The second holder 43 is positioned on the height adjuster 42 and configured for holding the blade 20 such that the blade 20 points to the molding surface 11 along a direction that is parallel to the central axis 12. The second controller 44 is configured for controlling the height adjuster 42 to adjust a height of the blade 20, according to the manufacturing parameters of the lens mold core 10.

In step 200, the lens mold core 10 and the blade 20 are set to respective origins, where the blade 20 points to the molding surface 11 exactly along the central axis 12.

In step 300, the blade 20 is adjusted to point to a cutting point on the molding surface 11 by the second driver 40. In this embodiment, the blade 20 is adjusted to a proper height by the height adjuster 42.

In step 400, the lens mold core 10 is driven to move toward the blade 20 along a direction that is substantially parallel to the central axis 12 and to spin about the central axis 12 until the blade 20 cuts into the molding surface 11 a desired depth, according to manufacturing parameters of the lens mold core 10.

In step 500, the lens mold core 10 is moved back to its origin and the blade 20 moves out of the lens mold core 10.

Steps 300, 400 and 500 are repeated until a plurality of circular and concentric micro-scaled residues are formed on the molding surface 11 and each residue is positioned between two adjacent cutting points. The blade 20 is adjusted to point to the cutting points in this order from the peripheral portion to the center of the molding surface 11 by the second driver 40 at a fixed pitch less than about 500 nm, according to the manufacturing parameters of the lens mold core 10, that is, the blade 20 is adjusted to a number of different heights at the fixed pitch. As a result, the residues cooperatively form a diffractive grating having a spatial cycle equal to the fixed pitch.

In other words, the blade 20 is driven to a number of cutting points in this order from the peripheral to the center of the molding surface 11 by the second driver 40 at a fixed pitch less than about 500 nm, according to the manufacturing parameters of the lens mold core 10, in step 300, and, the lens mold core 10 is driven to move toward the blade 20 along a direction that is substantially parallel to the central axis and to spin about the central axis at each cutting point until the blade 20 cuts into the molding surface 11 a desired depth, according to the manufacturing parameters of the lens mold core 10, in step 400.

It is proved by numerous experiments that a lens (not shown) molded by a lens mold core (not shown) manufactured by the present method except that the pitch is set larger than about 500 nm produces a rainbow flare. For example, the rainbow flare is obvious regardless of the incident angle of light rays when the pitch is set to 1666 nm, and the rainbow flare can be observed at 4 degrees −18 degrees away from a light source when light rays of the light source enter at an incident angle of about 26 degrees, provided that the pitch is set to 833 nm. However, no significant rainbow flare can be observed when a lens is molded by the lens mold core 10. For example, no rainbow flare can be observed in cases of any incident angle of light rays when the pitch is set to about 416 nm or 300 nm.

The manufacturing parameters includes the pitch, the diameter of the blade, the moving and rotating speeds of the mold core and so on.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the possible scope of the disclosure but do not restrict the scope of the disclosure.

What is claimed is:

1. A method for manufacturing a lens mold core, comprising:
providing a blade;
driving the blade to a plurality of cutting points in this order from the peripheral to the center of a molding surface of the lens mold core facing the blade at a fixed pitch less than about 500 nm, according to the manufacturing parameters of the lens mold core; and
driving the lens mold core to move toward the blade along a central axis of the molding surface and to spin about the central axis at each cutting point until the blade cuts into the molding surface a desired depth, according to the manufacturing parameters of the lens mold core.

2. The method of claim 1, further comprising:
setting the lens mold core and the blade to respective origins, where the blade points to the molding surface exactly along the central axis; and
restoring the lens mold core and the blade are restored to the respective origins after the cutting is finished at an old cutting point but before the blade is driven to a new cutting point.

3. The method of claim 1, wherein the pitch is set to about 416 nm.

4. The method of claim 1, wherein the pitch is set to about 300 nm.

5. A method for manufacturing a lens mold core, the lens mold core having a molding surface, the method comprising:
(a) providing a blade;
(b) driving the blade to point to a cutting point on the molding surface;
(c) driving the lens mold core to move toward the blade along a central axis of the molding surface and to spin about the central axis until the blade cuts into the molding surface a desired depth;
(d) moving the lens mold core back such that the blade moves out of the lens mold core; and
(e) repeating the steps (b), (c) and (d) until a plurality of circular and concentric micro-scaled residues are formed on the molding surface and each residue is positioned between two adjacent cutting points, wherein the blade is driven to point to the cutting points in this order from a peripheral portion to the center of the molding surface at a fixed pitch less than about 500 nm such that the residues cooperatively constitute a diffractive grating having a spatial cycle equal to the fixed pitch.

6. The method of claim 5, wherein in the step (a) the blade points to the molding surface exactly along the central axis.

7. The method of claim 5, wherein the fixed pitch is equal to about 416 nm.

8. The method of claim 5, wherein the fixed pitch is equal to about 300 nm.
